(19) United States
(12) Patent Application Publication
(10) Pub. No.: US 2026/0162266 A1
(43) Pub. Date: Jun. 11, 2026

(54) Tumor Position Determination Method and Electronic Device

(71) Applicant: OUR UNITED CORPORATION, Shaanxi (CN)

(72) Inventors: Dalin Liu, Shaanxi (CN); Hao Yan, Shaanxi (CN)

(21) Appl. No.: 19/413,423

(22) Filed: Dec. 9, 2025

(30) Foreign Application Priority Data
Dec. 10, 2024 (CN) 202411814029.3

(51) Int. Cl. G06T 7/00; G06T 7/38; G06T 17/00

(52) U.S. Cl. CPC G06T 7/0014; G06T 7/38; G06T 17/00; G06T 2207/10081; G06T 2207/30096

(57) ABSTRACT

The present disclosure provides a tumor position determination method and an electronic device. The method includes acquiring a projection image of a target object at a target angle, determining a target phase image whose image feature is the most similar to an image feature of the projection image from phase images of the target object, and determining a target initial position of the tumor of the target object corresponding to the target phase image, finally performing registration on the target phase image and the projection image based on the target initial position to obtain a position of the tumor of the target object. Herein, the projection image is a projection image obtained by imaging the tumor of the target object. The phase images include two-dimensional images of the target object at a plurality of respiratory phases at the target angle.

### CROSS-REFERENCE TO RELATED APPLICATION

This application claims priority to Chinese Patent Application No. 202411814029.3, filed Dec. 10, 2024, the disclosure of which is hereby incorporated by reference in its entirety.

### BACKGROUND OF THE INVENTION

### Field of the Invention

The present disclosure relates to the technical field of medical treatment, and in particular, to the technical field of tumor tracking, and more specifically to a tumor position determination method and an electronic device.

### Description of Related Art

During radiation therapy, maintaining precise positioning for a tumor is one of the key technologies of radiation therapy. During the radiation therapy, respiratory movement of a patient may cause significant changes in a position of a tumor in the chest or abdomen (such as lung, liver, or pancreas). Therefore, precise positioning for a chest or abdominal tumor has become a highly challenging issue.

At present, 10 phase images may be obtained through four dimensional computed tomography (4DCT), and a projection image of a patient collected during a treatment stage may be matched with the 10 phase images to obtain a position of a tumor.

### SUMMARY OF THE INVENTION

In a first aspect, a tumor position determination method is provided in the present disclosure, and the method includes:
acquiring a projection image of a target object at a target angle, determining a target phase image whose image feature is the most similar to an image feature of the projection image from phase images of the target object, and determining a target initial position of the tumor of the target object corresponding to the target phase image, finally performing registration on the target phase image and the projection image based on the target initial position to obtain a position of the tumor of the target object.

Herein, the projection image is a projection image obtained by imaging the tumor of the target object. The phase images include two-dimensional images of the target object at a plurality of respiratory phases at the target angle.

In a second aspect, a tumor position determination apparatus is provided in the present disclosure, and the apparatus includes:
an acquisition unit, configured to acquire a projection image of a target object at a target angle, where the projection image is a projection image obtained by imaging a tumor of the target object;
a determining unit, configured to determine a target phase image whose image feature is the most similar to an image feature of the projection image from phase images of the target object, and determine a target initial position of the tumor of the target object corresponding to the target phase image, where the phase images include two-dimensional images of the target object at a plurality of respiratory phases at the target angle; and
a registration unit, configured to perform registration on the target phase image and the projection image based on the target initial position to obtain a position of the tumor of the target object.

In a third aspect, the present disclosure further provides an electronic device, and the electronic device includes: a processor and a memory configured to store instructions executable for the processor; where the processor is configured to execute the instructions to implement any one of the tumor position determination methods in the above-mentioned first aspect.

### BRIEF DESCRIPTION OF THE DRAWINGS

The accompanying drawings are intended for a better understanding of the present scheme, and do not constitute the limitation of the present disclosure, where:

FIG. 1 is a schematic diagram of a scenario of a radiation therapy system provided in the embodiments of the present disclosure.

FIG. 2 is a flowchart of a tumor position determination method provided in the embodiments of the present disclosure.

FIG. 3 is a flowchart of another tumor position determination method provided in the embodiments of the present disclosure.

FIG. 4 is a flowchart of yet another tumor position determination method provided in the embodiments of the present disclosure.

FIG. 5 is a flowchart of yet another tumor position determination method provided in the embodiments of the present disclosure.

FIG. 6 is a schematic diagram of a tumor motion trajectory and a respiratory trajectory provided in the embodiments of the present disclosure.

FIG. 7 is a flowchart of yet another tumor position determination method provided in the embodiments of the present disclosure.

FIG. 8 is a schematic block diagram of an electronic device provided in the embodiments of the present disclosure.

### DESCRIPTION OF THE INVENTION

The technical solutions in the embodiments of present disclosure will be described below clearly and completely in conjunction with the accompanying drawings. Obviously, the described embodiments are merely a part of embodiments of the present disclosure, but not all of embodiments. All other embodiments obtained based on the embodiments of the present disclosure by those of ordinary skill in the art without paying any creative effort shall be included in the protection scope of the present disclosure.

In the description of the present disclosure, it will be understood that, orientations or positional relationships indicated by the terms such as “center”, “longitudinal”, “transverse”, “length”, “width”, “thickness”, “up”, “down”, “front”, “behind”, “left”, “right”, “vertical”, “horizontal”, “top”, “inner”, and “outer” are based on orientations or positional relationships shown in the accompanying drawings, which are merely for convenience in description of the present disclosure and simplifying the description, but not to indicate or imply that the indicated apparatuses or elements must have a specific orientation, or be constructed and operated in a specific orientation, thus cannot be understood as limitation of the present disclosure. In addition, terms “first”, “second” and “third” are merely used for a purpose of description, and cannot be understood as indicating or implying the relative importance or implicitly indicating the number of referred technical features. Thus, features defined with “first”, “second”, or “third” may explicitly or implicitly include one or more of the features. In the description of the present disclosure, “a plurality of” means two or more unless otherwise specified.

In the description of the present disclosure, the word “exemplary” is used to represent “being as an example, instance, or illustration.” Any embodiment in the present disclosure described as “exemplary” is not necessarily to be illustrated as preferred or advantageous over other embodiments in the present disclosure. The following description is presented to enable any skilled in the art to implement and use the present disclosure. In the following description, details are set forth for purposes of explanation. It should be understood that the ordinary technical personnel in the art may recognize that the present disclosure may be implemented without using these specific details. In other instances, well-known structures and processes are not described in detail to avoid obscuring the description of the present disclosure with unnecessary details. Thus, the present disclosure is not intended to be limited to the shown embodiments, but to be consistent with the widest scope of principles and features disclosed in the present disclosure.

It should be noted that since the method in the embodiments of the present disclosure is executed in an image computer device, and processing objects of various image computer devices exist in the form of data or information, such as time, which is essentially time information. It can be understood that in subsequent embodiments, if size, quantity, position, etc., are mentioned, they all exist in the form of corresponding data for processing by the computer device, and specific details will not be repeated herein.

During the radiation therapy, maintaining precise positioning for a tumor is one of the key technologies in the radiation therapy. During the radiation therapy, respiratory movement of a patient may cause significant changes in a position of a tumor in the chest or abdomen (such as lung, liver, or pancreas). Therefore, precise positioning for a chest or abdominal tumor has become a highly challenging issue.

At present, 10 phase images may be generated through a binning process of 4DCT (binning is mainly used to divide a respiratory cycle into different phase intervals), which correspond to 10 discrete positions of the tumor. The position of the tumor may be determined through matching 10 projection images of a patient collected during a treatment stage with the 10 phase images. But this method has the problem of underestimating tumor motion, that is, 10 phase images cannot include all positions of the tumor during a motion process. For example, in a case where the tumor is located in a position other than the 10 positions corresponding to the 10 phase images, it will not be possible to accurately locate the position of the tumor, that is, there is an extrapolation problem.

Based on the above technical problems, a tumor position determination method is provided in the present disclosure, a projection image of a target object is acquired at a target angle, a target phase image whose image feature is the most similar to an image feature of the projection image is determined from phase images of the target object, and a target initial position of the tumor of the target object corresponding to the target phase image is determined, finally registration is performed on the target phase image and the projection image based on the target initial position to obtain a position of the tumor of the target object. Herein, the projection image is a projection image obtained by imaging the tumor of the target object. The phase images include images of the target object at a plurality of respiratory phases.

Through the above technical solutions, after determining the target phase image whose image feature is the most similar to the image feature of the projection image, the registration may further be performed on the target phase image and the projection image based on the target initial position of the tumor of the target object corresponding to the target phase image to obtain the position of the tumor of the target object. Compared with related technologies in which the position of the tumor of the target object in the target phase image whose image feature is the most similar to the image feature of the projection image is directly taken as the position of the tumor of the target object in the projection image, the accuracy of tumor positioning may effectively be improved.

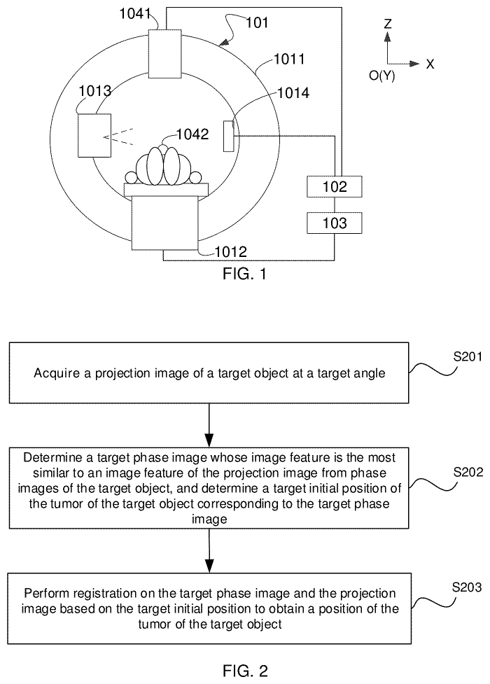

FIG. 1 is a schematic diagram of a radiation therapy system provided in the embodiments of the present disclosure, and the system may include an image guidance radiation therapy device 101, an image computer device 102, a control apparatus 103, and a respiration detection apparatus.

The image guiding radiation therapy device 101 may include a bracket 1011, and an image guidance apparatus and a bearing apparatus 1012 provided on the bracket 1011. Herein, the image guidance apparatus includes a light source 1013 and a detector 1014. The bearing apparatus 1012 is configured to support and move a target object, and the bearing apparatus 1012 may be a treatment bed. The light source 1013 is configured to emit a light beam, and the detector 1014 is configured to receive a light beam passing through the target object (i.e., patient) to generate a projection image of the target object.

In the embodiments of the present disclosure, the detector 1014 may be a flat-panel detector or a curved-surface detector. The shape and form of the detector 1014 may not be specifically limited in the embodiments of the present disclosure.

In the embodiments of the present disclosure, the image guidance apparatus may be at least one of: a cone beam computed tomography (CBCT) apparatus, a computed tomography (CT) apparatus, or a magnetic resonance (MR) apparatus. That is, the image guidance apparatus may be a CBCT apparatus, a CT apparatus, or an MR apparatus, or may include any two of a CBCT apparatus, a CT apparatus, and an MR apparatus. The image guidance apparatus may also include a CBCT apparatus, a CT apparatus, and an MR apparatus. The shape and form of the image guidance apparatus may not be specifically limited in the embodiments of the present disclosure.

In a case where the image guidance apparatus is a CBCT apparatus, the light source 1013 is an X-ray tube and the detector 1014 is a flat-panel detector.

In the embodiments of the present disclosure, there are no limitations on a number of light sources 1013 and detectors 1014. For example, the number of light sources 1013 may be one or multiple. Similarly, the number of detectors 1014 may be one or multiple. In a case where the number of light sources 1013 and the number of detectors 1014 are multiple, a plurality of two-dimensional images (i.e., projection images, also referred to as kilovolt (KV) images) for interior two-dimensional (2D) planes of the target object may be generated at a certain bracket angle (or time point).

In some embodiments, in a case where the number of light sources 1013 and the number of detectors 1014 are one, the light source and the detector may be located in the direction of the Z-axis shown in FIG. 1, so that the positions of the tumor of the target object in the X-axis direction and Y-axis direction may be obtained. Herein, the position of the tumor of the target object in the Y-axis direction represents a position of the tumor of the target object in a head-to-foot direction. The position of the tumor of the target object in the X-axis direction represents a position of the tumor of the target object in a left-to-right direction (i.e., on the left or right with respect to the target object).

In some embodiments, in a case where the number of light sources 1013 and the number of detectors 1014 are both two, one combination of a light source and a detector may be located in the Z-axis direction shown in FIG. 1 to obtain positions of the tumor of the target object in the X-axis direction and Y-axis direction, and another combination of a light source and a detector may be located in the X-axis direction shown in FIG. 1 to obtain positions of the tumor of the target object in the Z-axis direction and Y-axis direction. In this way, a three-dimensional spatial position of the tumor of the target object may be obtained based on the positions of the tumor of the target object in the X-axis direction and Y-axis direction and the positions of the tumor of the target object in the Z-axis direction and Y-axis direction. The position of the tumor of the target object in the Z-axis direction represents a position of the tumor of the target object in an front-to-behind direction (i.e., on the front or behind the target object, which is shown as up or down direction).

The bracket 1011 may be a ring bracket, a C-arm bracket, a drum bracket, a multi-layer bowl-shaped/cylindrical structure bracket, etc. The bracket 1011 may be a rotation bracket that can move around a rotation axis or an immovable fixed bracket. In a case where the bracket 1011 rotates, the light source 1013 and detector 1014 may rotate around the Y-axis by any angle, thus generating a two-dimensional image (i.e., projection image) of the target object in any 2D plane.

The respiration detection apparatus is detection to detect a respiratory signal of the target object.

In the embodiments of the present disclosure, the respiration detection apparatus may include an optical camera 1041 and at least one optical marker 1042 arranged on the chest surface of the target object. Exemplarily, the optical camera 1041 may be an infrared camera, and correspondingly, the optical marker 1042 may be an infrared marker, or the optical camera 1041 and the optical marker 1042 may be other types of optical cameras and compatible optical markers, respectively. The shape and form of the respiration detection apparatus is not specifically limited in the embodiments of the present disclosure.

The image computer device 102 is respectively connected to the control apparatus 103, detector 1014, and respiration detection apparatus (such as the optical camera 1041 in FIG. 1) for communication, and the control apparatus 103 is connected to the image guidance radiation therapy device 101 for communication.

In some embodiments, the image computer device 102 is a computer device having a graphical user interface (GUI), and the computer device includes: one or more processors, a memory, and one or more application programs. For example, the image computer device 102 may include an image guidance system (IGS) application program. A processor of the image computer device executes the IGS application program to: acquire a projection image of a target object at a target angle, determine a target phase image whose image feature is the most similar to an image feature of the projection image from phase images of the target object, and determine a target initial position of the tumor of the target object corresponding to the target phase image, finally perform registration on the target phase image and the projection image based on the target initial position to obtain a position of the tumor of the target object. Herein, the projection image is a projection image obtained by imaging a tumor of the target object. The phase images include two-dimensional images of the target object at a plurality of respiratory phases at the target angle.

In the embodiments of the present disclosure, the image computer device 102 and the control apparatus 103 may be independent servers, or may be a server network or server cluster composed of servers. For example, the computer device described in the embodiments of the present disclosure includes, but not limited to: a computer, a network host, a single network server, a set of multiple network servers, or a cloud server composed of multiple servers. Herein, a cloud server is composed of a large number of computers or network servers based on cloud computing.

In the embodiments of the present disclosure, the image computer device 102 and the control apparatus 103 may be general-purpose computer devices or special-purpose computer devices. In a specific implementation, the computer device may be a desktop computer, a portable computer, a network server, a palmtop computer (personal digital assistant, PDA), a mobile phone, a tablet computer, a wireless terminal device, a communication device, an embedded device, etc., and a type of computer device is not limited in the embodiment.

The following will describe the tumor position determination method provided in the embodiments of the present disclosure in combination with FIG. 1 and taking the image computer device in FIG. 1 with one light source and one detector as an example. FIG. 2 is a flowchart of a tumor position determination method provided in the embodiments of the present disclosure. As shown in FIG. 2, the method includes the following S201-S203.

In S201, a projection image of a target object at a target angle is acquired.

Herein, the projection image is a projection image obtained by imaging a tumor of the target object.

In the embodiments of the present disclosure, a number of target angles is related to a number of light sources and a number of detectors. For example, in a case where both the number of light sources and the number of detectors are 1, the number of target angle is 1, and in a case where both the number of light sources and the number of detectors are 2, the number of target angles is 2. The number of target angles is not specifically limited in the embodiments of the present disclosure.

Specifically, a light beam emitted by the light source at any one or more angles (hereinafter referred to as target angle) passes through the target object and reaches the detector, the detector may obtain the projection image of the target object at the target angle. Afterwards, the detector may send the projection image of the target object at the target angle to the image computer device. In this way, the image computer device may obtain the projection image of the target object at the target angle.

In S202, a target phase image whose image feature is the most similar to an image feature of the projection image is determined from phase images of the target object, and a target initial position of the tumor of the target object corresponding to the target phase image is determined.

Herein, the phase images include two-dimensional images of the target object at a plurality of respiratory phases at the target angle.

In the embodiments of the present disclosure, the number of respiratory phases is not limited, for example, the number of the respiratory phase may include 10 or 8.

Specifically, the image computer device may pre-store phase images of the target object at the plurality of respiratory phases and positions of the tumor of the target object in respective phase images. On this basis, the image computer device may first acquire phase images of the target object at the plurality of respiratory phases, and then compare the image feature of the projection image of the target object at the target angle with image features of phase images of the target object at the plurality of respiratory phases respectively by using a preset similarity measurement algorithm, and obtain the target phase image whose image feature is the most similar to the image feature of the projection image of the target object at the target angle. Afterwards, the image computer device takes a position of the tumor of the target object in the target phase image as the initial target position of the tumor of the target object.

In the embodiments of the present disclosure, during the similarity comparison process, the similarity measurement algorithm may be the normalized cross correlation (NCC) algorithm, or the normalized mutual information (NMI) algorithm, etc., which is not specifically limited in the embodiments of the present disclosure.

A specific implementation process of above-mentioned comparing the image feature of the projection image of the target object at the target angle with image features of phase images of the target object at the plurality of respiratory phases respectively may refer to related technologies, which will not be repeated herein.

In an implementation, the image computer device may refer to the following manner to obtain the phase images of the target object at the plurality of respiratory phases: performing digital reconstruction on three-dimensional images at the plurality of respiratory phases at the target angle to obtain DRR images at the plurality of respiratory phases; and taking the DRR images at the plurality of respiratory phases as the phase images of the target object at the plurality of respiratory phases.

Herein, the three-dimensional images at the plurality of respiratory phases may be CT images at the plurality of respiratory phases, or may also be CBCT images at the plurality of respiratory phases.

It should be noted that in the embodiments of the present disclosure, the CT images at the plurality of respiratory phases may also be referred to as 4DCT images, and the CBCT images at the plurality of respiratory phases may also be referred to as 4DCBCT images.

Specifically, the image computer device may store the three-dimensional images of the target object at the plurality of respiratory phases. For a three-dimensional image at each respiratory phase, the image computer device may perform digital reconstruction on the three-dimensional image at this respiratory phase to obtain a DRR image at this respiratory phase, which is the phase image at this respiratory phase. By repeating the above steps, the image computer device may obtain the phase images of the target object at respective respiratory phases.

In an implementation, initial positions of the tumor of the target object at the plurality of respiratory phases may be characterized by a tumor motion trajectory curve. In this way, the image computer device may not only determine a position of the tumor of the target object in a phase image at each respiratory phase based on the tumor motion trajectory curve, but also obtain a position of the tumor of the target object at a phase between two phases corresponding any two adjacent phase images. In this way, a position of the tumor of the target object except for positions corresponding to the phase images may be obtained.

In S203, registration is performed on the target phase image and the projection image based on the target initial position to obtain a position of the tumor of the target object.

In a case where the number of target angle is 1, the number of projection image of the target object obtained at the target angle is 1, and at this time, the obtained position of the tumor of the target object is a two-dimensional position.

In a case where the number of target angles is multiple, the number of projection images of the target object obtained at the target angles is multiple. At this time, the obtained position of the tumor of the target object is an N-dimensional position (N is greater than 2). For example, in a case where the target angles include two angles (such as 0° and 90°), there are two projection images of the target object obtained at the target angle. At this time, the obtained position of the tumor of the target object is a three-dimensional spatial position.

In the embodiments of the present disclosure, there is no limitation on the registration manner for the target phase image and the projection image by the image computer device. For example, the image computer device may perform registration on the target phase image and the projection image by adopting deformation registration. As another example, the image computer device may perform registration on the target phase image and the projection image by adopting template matching.

In an implementation, the image computer device performing registration on the target phase image and the projection image to obtain the position of the tumor of the target object may specifically include: performing registration on the target phase image and the projection image based on the target initial position to obtain a registration result; and obtaining the position of the tumor of the target object based on the registration result and the target initial position.

Specifically, after the image computer device performs registration on the target phase image and the projection image, and obtains the registration result, the registration result may be superimposed with the target initial position of the tumor of the target object to obtain the position of the tumor of the target object.

In the above technical solutions, after determining the target phase image (i.e., the DRR image) whose image feature is the most similar to the image feature of the projection image, the position of the tumor of the target object in the projection image is closer to the position of the tumor of the target object in the most similar DRR image. At this time, the projection image and the most similar DRR image are registered (by adopting deformation registration or template matching) to obtain the position of the tumor of the target object in the projection image, that is, the position of the tumor of the target object in the projection image is equal to the target initial position of the tumor of the target object plus the registration result. This method may effectively improve the accuracy of tumor positioning. Compared with related technologies in which the position of the tumor of the target object in the target phase image whose image feature is the most similar to the image feature of the projection image is directly taken as the position of the tumor of the target object in the projection image, the position of the tumor of the target object in the projection image determined by this method is not limited to the 10 positions corresponding to 10 phase images generated by the 4DCT binning process. In this way, the positions of the tumor of the target object determined by the tumor position determination method provided in the embodiments of the present disclosure are more continuously, and positions except for the positions corresponding to 10 phase images of 4DCT may be obtained.

It can be understood that the tumor position determination method provided in the embodiments of the present disclosure may be applied to a positioning stage before a radiation therapy and/or a real-time monitoring stage during the radiation therapy. The tumor position determination method shown in FIG. 2 will be further illustrated below with the following two examples: 1. a tumor position determination method applied to the real-time monitoring stage during the radiation therapy; 2. a tumor position determination method applied to the positioning stage before the radiation therapy.

1. A tumor position determination method applied to the real-time monitoring stage during the radiation therapy.

In a case where the tumor position determination method provided in the embodiments of the present disclosure is applied to the real-time monitoring stage during the radiation therapy, above-mentioned acquiring the projection image of the target object at the target angle in S201 refers to a projection image acquired in the real-time monitoring stage during the radiation therapy.

It should be noted that in a case where the tumor position determination method provided in the embodiments of the present disclosure is applied to the real-time monitoring stage during the radiation therapy, in the positioning stage before the radiation therapy, the tumor position determination method provided in the embodiments of the present disclosure may be applied for tumor positioning, or other methods may be applied for tumor positioning.

On this basis, in some embodiments, the three-dimensional images of the target object at the plurality of respiratory phases may be CT images (also referred to as planning images, 4DCT images) of the target object at the plurality of respiratory phases. Correspondingly, the phase images of the target object include DRR images corresponding to the CT images of the target object at the plurality of respiratory phases at the target angle. At this point, the CT images of the target object at the plurality of respiratory phases may be obtained by performing 4D tomographic imaging on the tumor of the target object in a case of formulating a treatment plan for the target object.

In some other embodiments, the three-dimensional images of the target object at the plurality of respiratory phases may be CBCT images (4DCBCT images) of the target object at the plurality of respiratory phases. Correspondingly, the phase images of the target object may be the DRR images corresponding to the CBCT images of the target object at the plurality of respiratory phases at the target angle. At this point, the CBCT images of the target object at the plurality of respiratory phases may be 4DCBCT images obtained by performing three-dimensional reconstruction on projection images at the same respiratory phase among projection images (or referred to as KV images, which are two-dimensional images) obtained by imaging the tumor of the target object in the positioning stage before the radiation therapy; or may also be 4DCBCT images obtained by performing three-dimensional reconstruction on the projection images at the same respiratory phase among projection images obtained by imaging the tumor of the target object after the positioning stage is finished.

The following will introduce the tumor position determination method shown in FIG. 2 by taking three-dimensional images of the target object at the plurality of respiratory phases being CT images of the target object at the plurality of respiratory phases and three-dimensional images of the target object at the plurality of respiratory phases being CBCT images of the target object at the plurality of respiratory phases as examples.

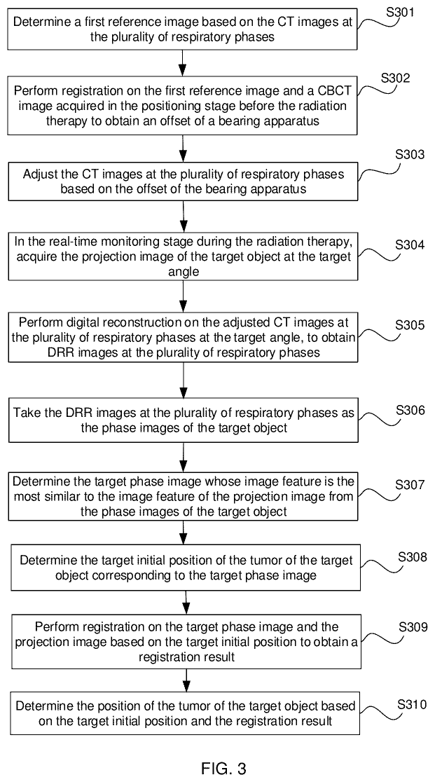

FIG. 3 is a flowchart for further introducing another tumor position determination method provided in the embodiments of the present disclosure with taking the three-dimensional images of the target object at the plurality of respiratory phases being the CT images (i.e., 4DCT images) of the target object at the plurality of respiratory phases, and images obtained during the positioning stage before the radiation therapy being the ordinary CBCT images as an example. As shown in FIG. 3, the method includes the following S301-S310.

In S301, a first reference image is determined based on the CT images at the plurality of respiratory phases.

Herein, the first reference image is an average intensity projection (AIP) image, which is a three-dimensional image.

Specifically, the image computer device may store CT images of the target object at the plurality of respiratory phases. On this basis, after the image computer device acquires the CT images of the target object at the plurality of respiratory phases, the image computer device may perform averaging processing on the CT images of the target object at the plurality of respiratory phases to obtain the AIP image (i.e., the first reference image) corresponding to the CT images at the plurality of respiratory phases.

Herein, performing the averaging process on the CT images of the target object at the plurality of respiratory phases may refer to the process of averaging a plurality of images in related technologies, which will not be repeated herein.

In S302, registration is performed on the first reference image and a CBCT image acquired in the positioning stage before the radiation therapy to obtain an offset of a bearing apparatus (also referred to as a bed displacement).

CBCT images are three-dimensional images obtained by reconstructing projection images of the target object obtained from different angles during the positioning stage before radiotherapy. The bearing apparatus (such as a treatment bed) is configured to bear the target object.

In the positioning stage before the radiation therapy, the image computer device may receive projection images of the target object at different angles sent from a detector of a CBCT apparatus. The image computer device may perform three-dimensional reconstruction on the projection images of target object at different angles to obtain a CBCT image. Afterwards, the image computer device may perform registration on the first reference image and the CBCT image to obtain the offset of the bearing apparatus, and the offset of the bearing apparatus is at least a three-dimensional offset.

In S303, the CT images at the plurality of respiratory phases are adjusted based on the offset of the bearing apparatus.

Specifically, for a CT image at each respiratory phase, the image computer device may adopt the offset of the bearing apparatus to adjust the position of the tumor of the target object in the CT image at that respiratory phase, and obtain the adjusted CT image at that respiratory phase. By repeating the above process, the image computer device may obtain adjusted CT images at the plurality of respiratory phases.

In S304, in the real-time monitoring stage during the radiation therapy, the projection image of the target object is acquired at the target angle.

A specific execution process of S304 may refer to the description in S201 above, which will not be repeated herein.

In S305, digital reconstruction is performed on the adjusted CT images at the plurality of respiratory phases at the target angle, to obtain DRR images at the plurality of respiratory phases.

In S306, the DRR images at the plurality of respiratory phases are taken as the phase images of the target object.

In S307, the target phase image whose image feature is the most similar to the image feature of the projection image is determined from the phase images of the target object.

In S308, the target initial position of the tumor of the target object corresponding to the target phase image is determined.

In S309, registration is performed on the target phase image and the projection image based on the target initial position to obtain a registration result.

In S310, the position of the tumor of the target object is determined based on the target initial position and the registration result.

The processes of S306-S310 mentioned above may refer to the description in FIG. 2, which will not be repeated herein.

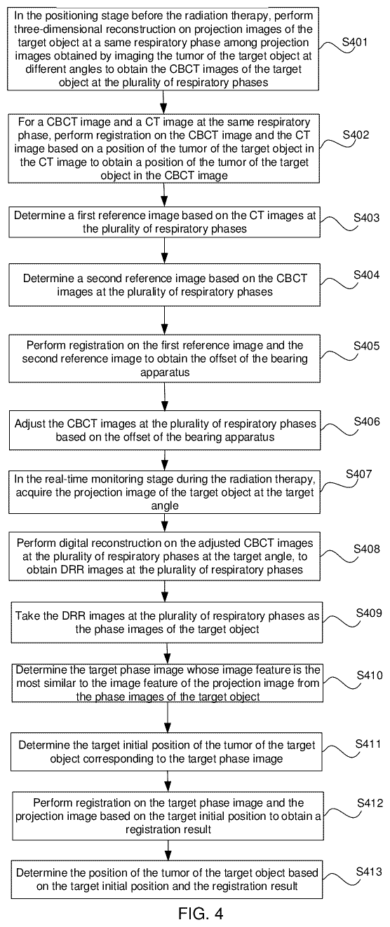

FIG. 4 is a flowchart for further introducing another tumor position determination method provided in the embodiments of the present disclosure with taking the three-dimensional images of the target object at the plurality of respiratory phases being the CBCT images (i.e., 4DCBCT images) of the target object at the plurality of respiratory phases, and the CBCT images of the target object at the plurality of respiratory phases being obtained in the positioning stage before the radiation therapy as an example. As shown in FIG. 4, the method includes the following S401-S413.

In S401, in the positioning stage before the radiation therapy, three-dimensional reconstruction is performed on projection images of the target object at a same respiratory phase among projection images obtained by imaging the tumor of the target object at different angles to obtain the CBCT images of the target object at the plurality of respiratory phases.

Specifically, in the positioning stage before the radiation therapy, the image computer device may receive projection images of the target object at different angles sent from a detector of a CBCT apparatus, and moments of harvesting the respective projection images. The image computer device may determine a projection image at each respiratory phase based on the moments of harvesting respective projection images and a moment corresponding to each respiratory phase. For a projection image at each respiratory phase, the image computer device may perform three-dimensional reconstruction on the projection image of that respiratory phase to obtain the CBCT image of the target object at that respiratory phase. By repeating the above steps, the image computer device may obtain CBCT images of the target object at the plurality of respiratory phases.

In S402, for a CBCT image and a CT image at the same respiratory phase, registration is performed on the CBCT image and the CT image based on a position of the tumor of the target object in the CT image to obtain a position of the tumor of the target object in the CBCT image.

Herein, a position of the tumor of the target object in any of the CBCT images is consistent with an initial position of the tumor of the target object in a phase image corresponding to the CBCT image. That is, the position of the tumor of the target object in the CBCT image at each respiratory phase is an initial position of the tumor of the target object in a DRR image (i.e., phase image) obtained by performing digital reconstruction on the CBCT image.

The position of the tumor of the target object in the CBCT image at each respiratory phase refers to a distance between the tumor of the target object and an image center in the CBCT image, that is, a three-dimensional spatial coordinate of the tumor of the target object in the CBCT image.

Specifically, for the CBCT image and the CT image at the same respiratory phase, the image computer device may perform registration on the CBCT image and the CT image at the same respiratory phase based on the position of the tumor of the target object in the CT image at that respiratory phase, in order to obtain the position of the tumor of the target object in the CBCT image.

In S403, a first reference image is determined based on the CT images at the plurality of respiratory phases.

A specific execution process of S403 may refer to the description in S301 above, which will not be repeated herein.

In S404, a second reference image is determined based on the CBCT images at the plurality of respiratory phases.

Specifically, after the image computer device obtains the CBCT images of the target object at the plurality of respiratory phases through the above-mentioned S401, the image computer device may perform averaging processing on the CBCT images of the target object at the plurality of respiratory phases to obtain an AIP image (i.e., the second reference image) corresponding to the CBCT images at the plurality of respiratory phases.

In S405, registration is performed on the first reference image and the second reference image to obtain the offset of the bearing apparatus.

In S406, the CBCT images at the plurality of respiratory phases are adjusted based on the offset of the bearing apparatus.

A specific execution process may refer to S303 mentioned above, which will not be repeated herein.

In S407, in the real-time monitoring stage during the radiation therapy, the projection image of the target object is acquired at the target angle.

A specific execution process of S407 may refer to the description in S201 above, which will not be repeated herein.

In S408, digital reconstruction is performed on the adjusted CBCT images at the plurality of respiratory phases at the target angle, to obtain DRR images at the plurality of respiratory phases.

In S409, the DRR images at the plurality of respiratory phases are taken as the phase images of the target object.

In S410, the target phase image whose image feature is the most similar to the image feature of the projection image is determined from the phase images of the target object.

In S411, the target initial position of the tumor of the target object corresponding to the target phase image is determined.

In S412, registration is performed on the target phase image and the projection image based on the target initial position to obtain a registration result.

In S413, the position of the tumor of the target object is determined based on the target initial position and the registration result.

A specific implementation of S408-S413 may refer to the description in FIG. 2 above, which will not be repeated herein.

In the above technical solutions, 4DCBCT image in the positioning stage is used to instead of 4DCT image as the three-dimensional image of the target object, and digital reconstruction is performed based on the 4DCBCT image to obtain phase images of the target object at the plurality of respiratory phases. In this way, the phase images of the target object at the plurality of respiratory phases may be made closer to a physical state of the target object during the radiation therapy, thereby further improving the accuracy of tumor positioning.

In addition, it should be noted that: in a case where the three-dimensional images of the target object at the plurality of respiratory phases are the CBCT images of the target object at the plurality of respiratory phases, and the CBCT images of the target object at the plurality of respiratory phases are obtained after the positioning stage is finished, there is no need to adjust the CBCT images at the plurality of respiratory phases adopting the offset of the bearing apparatus, that is, there is no need to perform the above-mentioned S405 and S406. Correspondingly, the above-mentioned S407 may be replaced by performing digital reconstruction on the CBCT images at the plurality of respiratory phases at the target angle to obtain the DRR images at the plurality of respiratory phases.

2. The tumor position determination method applied to the positioning stage before the radiation therapy.

In a case where the tumor position determination method provided in the embodiments of the present disclosure is applied to the positioning stage before the radiation therapy, acquiring the projection image of the target object at the target angle in S201 refers to a projection image acquired in the positioning stage before the radiation therapy at any angle.

It can be understood that the projection images obtained at various angles in the positioning stage may be projection images at different angles obtained by scanning based on a case of the CBCT apparatus acquiring the CBCT images, or may be projection images at different angles and different respiratory phases obtained by scanning based on a case of the CBCT apparatus and the respiration detection apparatus acquiring 4DCBCT images.

It should be noted that in a case where the tumor position determination method provided in the embodiments of the present disclosure is applied to the positioning stage before the radiation therapy, in the real-time monitoring stage during the radiation therapy, the tumor position determination method provided in the embodiments of the present disclosure may be applied for tumor position monitoring, or other methods may be applied for tumor position monitoring.

On this basis, in some embodiments, the three-dimensional images of the target object at the plurality of respiratory phases may be CT images (i.e., 4DCT images) of the target object at the plurality of respiratory phases. Correspondingly, the phase images of the target object include DRR images corresponding to the CT images of the target object at the plurality of respiratory phases at the target angle.

In some other embodiments, the three-dimensional images of the target object at the plurality of respiratory phases may be CBCT images (i.e., 4DCBCT images) of the target object at the plurality of respiratory phases. Correspondingly, the phase images of the target object may be the DRR images corresponding to the CBCT images of the target object at the plurality of respiratory phases at the target angle.

The following will introduce the tumor position determination method shown in FIG. 2 by taking three-dimensional images of the target object at the plurality of respiratory phases being CT images of the target object at the plurality of respiratory phases, and three-dimensional images of the target object at the plurality of respiratory phases being CBCT images of the target object at the plurality of respiratory phases as examples.

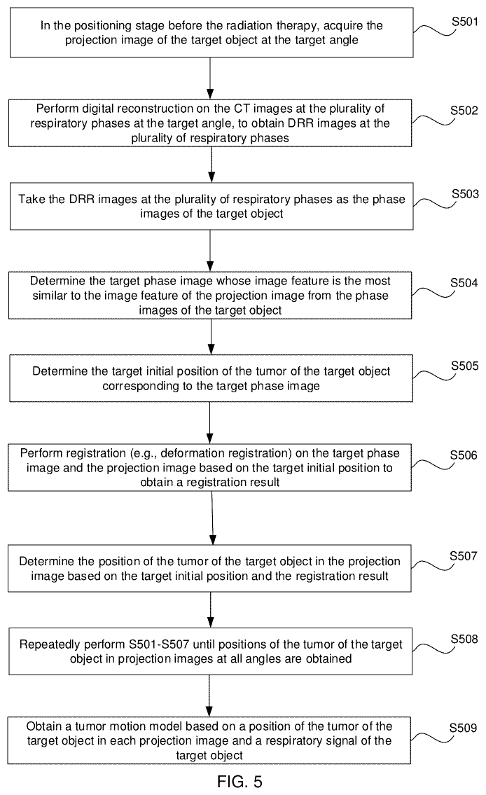

FIG. 5 is a flowchart for further introducing yet another tumor position determination method provided in the embodiments of the present disclosure with taking the three-dimensional images of the target object at the plurality of respiratory phases being the CT images of the target object at the plurality of respiratory phases, and the projection images acquired in the positioning stage being projection images at different angles obtained by scanning based on a case of the CBCT apparatus acquiring the CBCT images as an example. As shown in FIG. 5, the method includes the following S501-S509.

In S501, in the positioning stage before the radiation therapy, the projection image of the target object is acquired at the target angle.

The target angle is any angle.

In S502, digital reconstruction is performed on the CT images at the plurality of respiratory phases at the target angle, to obtain DRR images at the plurality of respiratory phases.

In S503, the DRR images at the plurality of respiratory phases are taken as the phase images of the target object.

In S504, the target phase image whose image feature is the most similar to the image feature of the projection image is determined from the phase images of the target object.

In S505, the target initial position of the tumor of the target object corresponding to the target phase image is determined.

In S506, registration (e.g., deformation registration) is performed on the target phase image and the projection image based on the target initial position to obtain a registration result.

In S507, the position of the tumor of the target object in the projection image is determined based on the target initial position and the registration result.

Specific execution processes of S501-S507 may refer to the description in FIG. 2 above, which will not be repeated herein.

In S508, S501-S507 are repeatedly performed until positions of the tumor of the target object in projection images at all angles are obtained.

In S509, a tumor motion model is obtained based on a position of the tumor of the target object in each projection image and a respiratory signal of the target object.

Herein, the tumor motion model is used to characterize a positional changes of the tumor of the target object during a respiratory process of the target object.

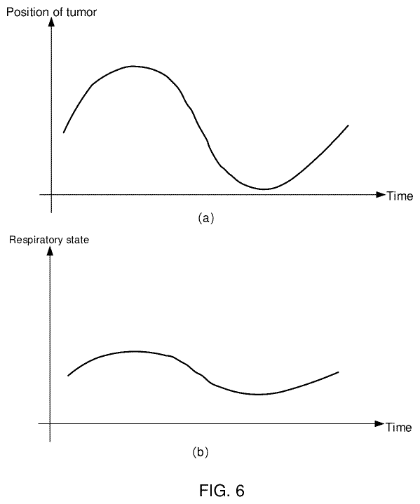

Specifically, after the image computer device determines the positions of the tumor of the target object in respective projection images, a motion trajectory (including a motion trajectory of the tumor of the target object in the X axis, a motion trajectory of the tumor of the target object in the Y axis, and a motion trajectory of the tumor of the target object in the Z axis) of the tumor of the target object may be generated based on the positions of the tumor of the target object in the respective projection images and moments of harvesting respective projection images. Further, a manifestation of each motion trajectory is a sine function as shown in (a) of FIG. 6, with the horizontal axis representing time and the vertical axis representing the position (on the X, Y, or Z axis) of the tumor of the target object. The image computer device may further determine a respiratory trajectory of the target object based on a respiratory signal and a harvesting frequency for the target object. Further, a manifestation of the respiratory trajectory is a sine function as shown in (b) of FIG. 6, with the horizontal axis representing time and the vertical axis representing a respiratory state of the target object.

Afterwards, the image computer device may determine the first reference image based on the CT images at the plurality of respiratory phases, and determine a bed displacement based on the position of the tumor of the target object in the first reference image and the position of the tumor of the target object in the CBCT image obtained in the positioning stage before the radiation therapy. The image computer device may adjust the motion trajectory of the tumor of the target object adopting the bed displacement, and obtain the tumor motion model of the target object (including the tumor motion model of the target object in the X axis, Y axis, and Z axis) by adopting a motion model generation method based on the adjusted motion trajectory of the tumor of the target object and the respiratory trajectory of the target object. The tumor motion model is used to characterize a mapping relationship between a respiratory state of the target object and the position of the tumor of the target object.

In the embodiments of the present disclosure, the motion model generation method may be a polynomial fitting method, or may also be a linear regression method, or a neural network method (such as a multi-layer perceptron), which is not limited in the embodiments of the present disclosure.

Specifically, the process of obtaining the tumor motion model of the target object based on the motion trajectory of the tumor of the target object and the respiratory trajectory of the target object may refer to related technologies, which will not be repeated herein.

In an implementation, after determining the tumor motion model through the above manner, the image computer device may determine the position of the tumor of the target object in real time based on the tumor motion model.

Specifically, after obtaining the tumor motion model, in the real-time monitoring stage during the radiation therapy, the image computer device may obtain the respiratory state of the target object in real time through the respiratory detection device, and determine the position of the tumor of the target object in real time based on the respiratory state of the target object and the tumor motion model, achieving prediction for the tumor position. Afterwards, the image computer device may control the emitting of a treatment beam through the control apparatus based on the determined position of the tumor of the target object to make it reach the tumor of the target object through a multi leaf collimator (MLC), achieving treatment for the tumor of the target object.

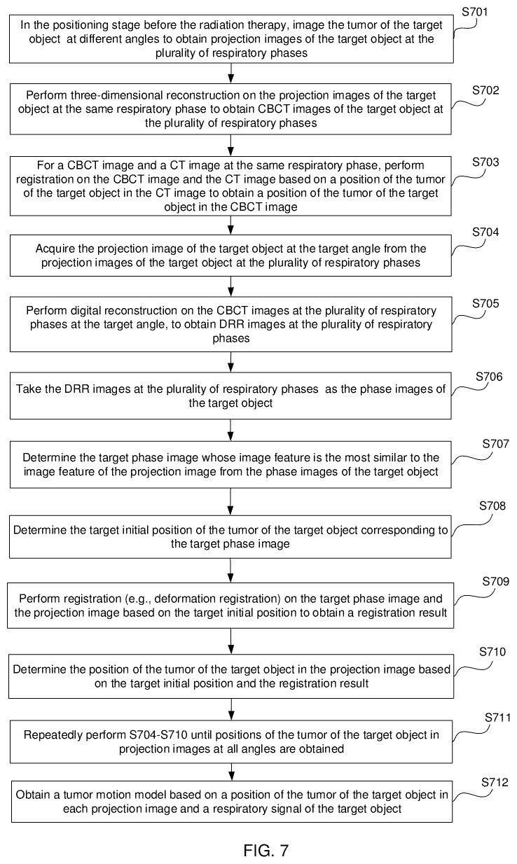

FIG. 7 is a flowchart for further introducing another tumor position determination method provided in the embodiments of the present disclosure with taking the three-dimensional images of the target object at the plurality of respiratory phases being the CBCT images of the target object at the plurality of respiratory phases, and the CBCT images of the target object at the plurality of respiratory phases being obtained in the positioning stage before the radiation therapy as an example. As shown in FIG. 7, the method includes the following S701-S712.

In S701, in the positioning stage before the radiation therapy, the tumor of the target object is imaged at different angles to obtain projection images of the target object at the plurality of respiratory phases.

In S702, three-dimensional reconstruction is performed on the projection images of the target object at the same respiratory phase to obtain CBCT images of the target object at the plurality of respiratory phases.

In S703, for a CBCT image and a CT image at the same respiratory phase, registration is performed on the CBCT image and the CT image based on a position of the tumor of the target object in the CT image to obtain a position of the tumor of the target object in the CBCT image.

Specific execution processes of S701-S703 may refer to the description in S401-S402 above, which will not be repeated herein.

In S704, the projection image of the target object at the target angle is acquired from the projection images of the target object at the plurality of respiratory phases.

The target angle is any angle.

In S705, digital reconstruction is performed on the CBCT images at the plurality of respiratory phases at the target angle, to obtain DRR images at the plurality of respiratory phases.

In S706, the DRR images at the plurality of respiratory phases are taken as the phase images of the target object.

In S707, the target phase image whose image feature is the most similar to the image feature of the projection image is determined from the phase images of the target object.

In S708, the target initial position of the tumor of the target object corresponding to the target phase image is determined.

In S709, registration (e.g., deformation registration) is performed on the target phase image and the projection image based on the target initial position to obtain a registration result.

In S710, the position of the tumor of the target object in the projection image is determined based on the target initial position and the registration result.

Specific execution processes of S705-S710 may refer to the description in FIG. 2 above, which will not be repeated herein.

In S711, S704-S710 are repeatedly performed until positions of the tumor of the target object in projection images at all angles are obtained.

In S712, a tumor motion model is obtained based on a position of the tumor of the target object in each projection image and a respiratory signal of the target object.

A specific execution process of S712 may refer to the description in S509 above, which will not be repeated herein.

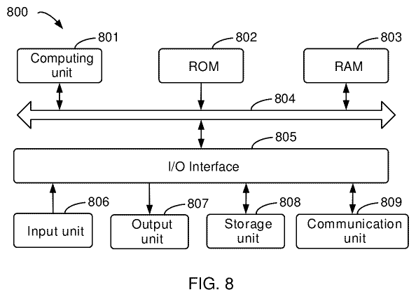

FIG. 8 shows a schematic block diagram of an example electronic device 800 that is capable of being configured to implement the embodiments of the present disclosure. An electronic device is intended to represent various forms of digital computers, such as laptops, desktops, workstations, personal digital assistants, servers, blade servers, mainframes, and other appropriate computers. The electronic device may also represent various forms of mobile apparatuses, such as personal digital assistants, cellular phones, smart phones, wearable devices, and other similar computing apparatuses. The components shown herein, their connections and relationships, and their functions, are intended only as examples, and are not meant to limit implementations of the present disclosure described and/or claimed herein. In some embodiments, the electronic device may be the image computer device shown in above-mentioned FIG. 1.

As shown in FIG. 8, the electronic device 800 includes a computing unit 801, which may perform various appropriate actions and processes according to computer programs stored in a read-only memory 802 or computer programs loaded from a storage unit 808 to a random access memory 803. Various programs and data required for operations of the electronic device 800 may further be stored in the random access memory (RAM) 803. The computing unit 801, the read-only memory (ROM) 802, and the RAM 1203 are connected to each other via a bus 804. An input/output (I/O) interface 805 is also connected to the bus 804.

Multiple components in the electronic device 800 are connected to the input/output interface 805, and include: an input unit 806 (such as a keyboard, a mouse, etc.); an output unit 807 (such as various types of displays, speakers, etc.); a storage unit 808 (such as a disk, an optical disk, etc.); and a communication unit 809 (such as a network card, a modem, a wireless communication transceiver, etc.). The communication unit 809 allows the electronic device 800 to exchange information/data with other devices through computer networks such as the Internet and/or various telecommunications networks.

The computing unit 801 may be a various general and/or special processing components having processing and computing capabilities. Some examples of the computing unit 801 include, but are not limited to, a central processing unit, a graphics processing unit (graphics processing unit, GPU), various dedicated artificial intelligence (artificial intelligence, AI) computing chips, various computing units that run machine learning model algorithms, a digital signal processor, and any appropriate processors, controllers, microcontrollers, etc. The computing unit 801 performs the various methods and processes as described above, such as the tumor position determination method. For example, in one embodiment, the tumor position determination method may be implemented as computer software programs, which are tangibly included in a machine-readable medium, such as the storage unit 808. In one embodiment, a portion or all of the computer programs may be loaded and/or installed on the electronic device 800 via the ROM 802 and/or the communication unit 809. In a case where the computer programs are loaded into the RAM 803 and executed by the computing unit 801, one or more steps of the tumor position determination method described above may be performed. Alternatively, in other embodiments, the computing unit 801 may be configured to perform the tumor position determination method in any other appropriate manners (e.g., by means of firmware).

Various implementations of the systems and techniques described above in the present document may be realized in a digital electronic circuit system, an integrated circuit system, a field programmable gate array, an application specific integrated circuit, application specific standard parts (ASSP), a system on chip (SOC), a complex programmable logic device (CPLD), a computer hardware, firmware, software, and/or combinations thereof. These various implementations may include: being implemented in one or more computer programs, where the one or more computer programs may be executed and/or interpreted on a programmable system including at least one programmable processor, and a programmable processor may be a special purpose or general purpose programmable processor that can receive data and instructions from a storage system, at least one input device, and at least one output device, and transmit data and instructions to the storage system, the at least one input device, and the at least one output device.

Program codes for implementing the methods of the present disclosure may be written in any combination of one or more programming languages. These program codes may be provided to a processor or a controller of a general-purpose computer, a special-purpose computer or other programmable data processing devices, so that when the program codes are executed by the processor or controller, the functions/operations specified in the flowcharts and/or block diagrams are implemented. The program codes may be executed entirely on the machine, executed partly on the machine, may be as a stand-alone software package, and partly executed on the machine and partly executed on a remote machine, or entirely executed on the remote machine or server.

In the context of the present disclosure, a machine-readable medium may be a tangible medium, which may contain or store programs for use by an instruction execution system, apparatus, or device, or for use in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include electrical connections based on one or more wires, a portable computer disk, a hard disk, a random access memory, a read-only memory, an erasable programmable read-only memory, optical fibers, a portable compact disk read-only memory, an optical storage device, a magnetic storage device, or any suitable combination thereof.

To provide interaction with a user, systems and techniques described herein may be implemented on a computer, and the computer has: a display apparatus (such as a cathode ray tube (CRT) or a liquid crystal display (LCD) monitor) for displaying information to the user; and a keyboard and a pointing apparatus (such as a mouse or trackball), and the user may provide input to the computer through the keyboard and the pointing apparatus. Other types of apparatuses may also be configured to provide interaction with the user; for example, a feedback provided to the user may be any form of sensory feedback (e.g., a visual feedback, an auditory feedback, or a tactile feedback); and input from the user may be received in any form (including an acoustic input, a voice input, or a tactile input).

The systems and techniques described herein may be implemented in a computing system that includes back-end components (e.g., as a data server), or a computing system that includes middleware components (e.g., an application server), or a computing system that includes front-end components (e.g., a user computer with a graphical user interface or a web browser, and a user may interact with implementations of the systems and techniques described herein through the web browser), or a computing system that includes any combination of such back-end components, middleware components, or front-end components. The components of the system may be interconnected by any form or media of digital data communication (e.g., a communication network). Examples of the communication network include a local area network (LAN), a wide area network (WAN), and the Internet.

A computer system may include a client and a server. The client and server are generally remote from each other and typically interact with each other through the communication network. A relationship of the client and server is arisen by computer programs running on the corresponding computers and having a client-server relationship to each other. The server may be a cloud server, or also may be a server of a distributed system, or a server combined with blockchains.

It should be understood that various forms of the processes shown above may be used with steps being reordered, added or deleted. For example, the various steps described in the present disclosure may be executed in parallel, or may also be executed sequentially, or may be executed in different orders, as long as the expected results of the technical solutions in the present disclosure can be achieved, and the orders for executing the steps are not limited herein.

The specific implementations mentioned above do not limit the scope of the present disclosure. It should be understood by those skilled in the art that various modifications, combinations, sub-combinations and substitutions may be made according to design requirements and other factors. Any modifications, equivalent substitutions, and improvements made within the principles of the present disclosure shall be included within the scope of protection of the present disclosure.

What is claimed is:

1. A tumor position determination method, wherein the method comprises:
acquiring a projection image of a target object at a target angle, wherein the projection image is a projection image obtained by imaging a tumor of the target object;
determining a target phase image whose image feature is the most similar to an image feature of the projection image from phase images of the target object, and determining a target initial position of the tumor of the target object corresponding to the target phase image, wherein the phase images include two-dimensional images of the target object at a plurality of respiratory phases at the target angle; and
performing registration on the target phase image and the projection image based on the target initial position to obtain a position of the tumor of the target object.

2. The method according to claim 1, wherein performing registration on the target phase image and the projection image based on the target initial position to obtain the position of the tumor of the target object comprising:
performing registration on the target phase image and the projection image to obtain a registration result; and
determining the position of the tumor of the target object based on the target initial position and the registration result.

3. The method according to claim 1, wherein performing registration on the target phase image and the projection image comprises:
performing registration on the target phase image and the projection image by adopting deformation registration; or
performing registration on the target phase image and the projection image by adopting template matching.

4. The method according to claim 1, wherein the method further comprises:
performing digital reconstruction on three-dimensional images at the plurality of respiratory phases at the target angle to obtain digitally reconstructed radiograph (DRR) images at the plurality of respiratory phases; and
taking the DRR images at the plurality of respiratory phases as the phase images.

5. The method according to claim 4, wherein the three-dimensional images at the plurality of respiratory phases include at least one of: computed tomography (CT) images at the plurality of respiratory phases or cone beam computed tomography (CBCT) images at the plurality of respiratory phases.

6. The method according to claim 1, wherein the tumor position determination method is applied to at least one of: a positioning stage before a radiation therapy or a real-time monitoring stage during the radiation therapy.

7. The method according to claim 5, wherein in response to that the tumor position determination method is applied to a real-time monitoring stage during a radiation therapy, before performing digital reconstruction on the three-dimensional images at the plurality of respiratory phases at the target angle, the method further comprises:
determining an offset of a bearing apparatus, wherein the bearing apparatus is configured to bear the target object; and
adjusting the three-dimensional images at the plurality of respiratory phases based on the offset of the bearing apparatus;
wherein performing digital reconstruction on the three-dimensional images at the plurality of respiratory phases at the target angle comprises:
performing digital reconstruction on the adjusted three-dimensional images at the plurality of respiratory phases at the target angle.

8. The method according to claim 7, wherein the three-dimensional images at the plurality of respiratory phases are CT images at the plurality of respiratory phases;
wherein determining the offset of the bearing apparatus comprises:
determining a first reference image based on the CT images at the plurality of respiratory phases; and
performing registration on the first reference image and a CBCT image acquired during a positioning stage before a radiation therapy to obtain the offset of the bearing apparatus, wherein the CBCT image is a three-dimensional image obtained by reconstructing projection images of the target object obtained at different angles during the positioning stage.

9. The method according to claim 5, wherein the three-dimensional images at the plurality of respiratory phases are CBCT images at the plurality of respiratory phases, and the method further comprises:
performing three-dimensional reconstruction on projection images of the target object at a same respiratory phase among projection images obtained by imaging the tumor of the target object at different angles to obtain the CBCT images of the target object at the plurality of respiratory phases.

10. The method according to claim 7, wherein the three-dimensional images at the plurality of respiratory phases are CBCT images at the plurality of respiratory phases;
wherein determining the offset of the bearing apparatus comprises:
determining a first reference image based on the CT images at the plurality of respiratory phases;
determining a second reference image based on the CBCT images at the plurality of respiratory phases; and
performing registration on the first reference image and the second reference image to obtain the offset of the bearing apparatus.

11. The method according to claim 5, wherein the three-dimensional images at the plurality of respiratory phases are CBCT images at the plurality of respiratory phases, and the method further comprises:
for a CBCT image and a CT image at a same respiratory phase, performing registration on the CBCT image and the CT image based on a position of the tumor of the target object in the CT image to obtain a position of the tumor of the target object in the CBCT image;
wherein a position of the tumor of the target object in any of the CBCT images is consistent with an initial position of the tumor of the target object in a phase image corresponding to the CBCT image.

12. The method according to claim 1, wherein initial positions of the tumor of the target object at the plurality of respiratory phases are characterized by a tumor motion trajectory curve.

13. The method according to claim 1, wherein the projection image is any one of a plurality of projection images harvested during a positioning stage before a radiation therapy;
wherein the method further comprises:
obtaining a tumor motion model based on a position of the tumor of the target object in each projection image among the plurality of projection images and a respiratory signal of the target object, wherein the tumor motion model is used to characterize a positional changes of the tumor of the target object during a respiratory process of the target object.

14. The method according to claim 13, wherein the method further comprises:
determining the position of the tumor of the target object in real time based on the tumor motion model.

15. An electronic device, wherein the electronic device comprises:
a processor; and
a memory configured to store instructions executable for the processor;
wherein the processor is configured to execute the instructions, to:
acquire a projection image of a target object at a target angle, wherein the projection image is a projection image obtained by imaging a tumor of the target object;
determine a target phase image whose image feature is the most similar to an image feature of the projection image from phase images of the target object, and determine a target initial position of the tumor of the target object corresponding to the target phase image, wherein the phase images include two-dimensional images of the target object at a plurality of respiratory phases at the target angle; and
perform registration on the target phase image and the projection image based on the target initial position to obtain a position of the tumor of the target object.

16. The electronic device according to claim 15, wherein in order to perform registration on the target phase image and the projection image based on the target initial position to obtain the position of the tumor of the target object, the processor is further configured to:
perform registration on the target phase image and the projection image to obtain a registration result; and
determine the position of the tumor of the target object based on the target initial position and the registration result.

17. The electronic device according to claim 15, wherein in order to perform registration on the target phase image and the projection image, the processor is further configured to:
perform registration on the target phase image and the projection image by adopting deformation registration; or
performing registration on the target phase image and the projection image by adopting template matching.

18. The electronic device according to claim 15, wherein the processor is further configured to:
perform digital reconstruction on three-dimensional images at the plurality of respiratory phases at the target angle to obtain digitally reconstructed radiograph (DRR) images at the plurality of respiratory phases; and
take the DRR images at the plurality of respiratory phases as the phase images.

19. The electronic device according to claim 18, wherein the three-dimensional images at the plurality of respiratory phases include at least one of: computed tomography (CT) images at the plurality of respiratory phases or cone beam computed tomography (CBCT) images at the plurality of respiratory phases.

20. The electronic device according to claim 15, wherein the tumor position determination method is applied to at least one of: a positioning stage before a radiation therapy or a real-time monitoring stage during the radiation therapy.
